(19) United States
(12) Patent Application Publication
(10) Pub. No.: US 2007/0261920 A1
(43) Pub. Date: Nov. 15, 2007

(54) Rescue Apparatus

(76) Inventor: Rune Loraas, Notteroy (NO)

Correspondence Address: WENDEROTH, LIND & PONACK, L.L.P., 2033 K STREET N. W., SUITE 800, WASHINGTON, DC, 20006-1021, US

(21) Appl. No.: 11/666,881

(22) PCT Filed: Nov. 1, 2005
(86) PCT No.: PCT/NO05/00412

§ 371 Date: May 2, 2007

(30) Foreign Application Priority Data
Nov. 5, 2004 (NO) 20044833

(51) Int. Cl. E06C 7/00

(52) U.S. Cl. 182/228.1

(57) ABSTRACT

A rescue apparatus for rescuing casualties out of the water, from wharfs, docks, piers, quays, boats etc., comprising a fist general ladder part and a fork-like device (1) having fork arms extending perpendicularly to the longitudinal axis of the ladder rungs, the fork-like device being attached to the ladder part.

### BACKGROUND OF THE INVENTION

1. Field of the Invention

The invention relates to a rescue apparatus for rescuing people out of the water, from wharfs, docks, piers, quays, boats, etc.

For people finding a casualty in water, it is often difficult to help the person concerned out of the water. The person that is to be brought out of the water is hard to get to, and also very heavy to lift. For a successful rescue, it is of vital importance that the casualty is brought out of the water quickly. Today, often a lightweight boat will be needed for bringing the person out of the water, which delays the rescue.

Using the invention, two people may easily rescue a casualty out of the water. The casualty may be lifted out of the water in a horizontal position, which is important in the case of a hypothermic (severely cooled down) person, as he or she may easily suffer cardiac arrest if being rescued in an upright position. If the casualty is conscious, and is not hypothermic, the person concerned can also be rescued in a vertical position. If somebody has to get into the water during a rescue operation, the invention may also be used as a ladder by turning it upside down with the gripping arms facing inwards onto a dock, pier, wharfside, etc.

2Related Art

From the patent NO 1987-3489, an arrangement for rescuing a person that has fallen into the water is known, comprising a ladder that may be lowered down into the water, and to the ladder, a lifting frame is slidingly attached. As I understand it, this device is a fixedly arranged apparatus including a lot of mechanical components, and is therefore not an easily available manual rescue apparatus that may be used anywhere there is a need for rescuing a person that has fallen into the water.

From the U.S. Pat. No. 5,624,292, an arrangement for rescuing a person that has fallen into the water is known, comprising an inflatable floating body designed so as to be attachable to a ladder. As I understand it, this arrangement functions as an extension from a seaside position and out into the water, and not as a manual rescue apparatus for lifting a person out of the water.

### SUMMARY OF THE INVENTION

The present invention aims at remedying the above problems by providing an apparatus as set forth in the independent claim 1.

### SHORT DESCRIPTION OF THE DRAWINGS

The invention is shown in the drawings, wherein

FIG. 1 shows a side view of the apparatus, and

FIG. 2 shows the apparatus as seen in a front view. The gripping arms (1) are in a manner that is not set forth in detail here attached at the upper corners of the frame (2). The gripping arms are parallel with each other and oriented in an angle of 90 degrees to the frame. The attachments (3) are positioned on an opposite side of the frame.

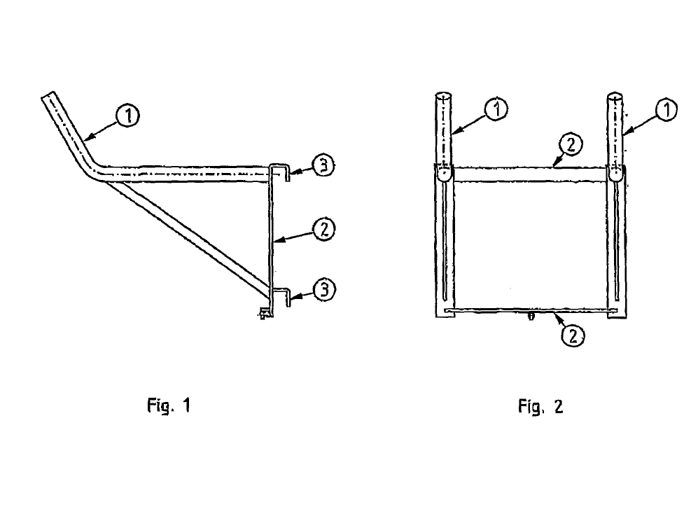

### DETAILED DESCRIPTION OF THE INVENTION

The invention is a rescue apparatus having two gripping arms that may easily be mounted to a ladder. The rescue apparatus is comprised of a frame including attachments for securing it to a ladder, as well as a locking device. Onto the frame, two arms are attached that are being used as gripping arms. The gripping arms are sized so as to have a sufficient strength, while at the same time being shaped so as to not inflict unnecessary injury to the casualty. The gripping arms have a bearing surface/length that is sufficient for enabling the rescue of people of different size. The gripping arms are attached at the top of the frame and point 90 degrees out and away from the frame. In order to ensure that the casualty will not slide out from the rescue apparatus, the outermost part of the gripping arms are curved upwards, typically 60 degrees. So that the gripping arms shall be able to carry the weight of a casualty, as well as have a strength that enables them to be forced into ice, stiffening members are provided between the lower part of the frame and the outer part of the gripping arms. The attachments are designed for easy installation onto a ladder. The locking device is a spring-loaded lock that grips below a ladder rung and thereby secures the apparatus to the ladder.

1. Manual rescue apparatus for lifting a person out of a liquid, comprising a first general ladder part and a lifting part attached to the ladder part, characterized in that the lifting part comprises:
a fork-like device having two or more fork arms (1), wherein the fork arms (1) extend approximately perpendicular to the longitudinal axis of the ladder rungs, the fork arms (1) further forming an angle of between 0 and 90 degrees between the legs of the ladder and the fork arms (1), and wherein the fork-like device is fixed to the ladder part.

2. A rescue apparatus according to claim 1, characterized in that the fork-like device comprises two fork arms (1).

3. A rescue apparatus according to claim 2, characterized in that the two fork arms (1) are identical, and that they at a first end facing away from the ladder are curved, the curve extending approximately perpendicular to the longitudinal axis of the ladder rungs, the curve further forming an angle of between 0 and 60 degrees to a line being parallel with the second and innermost part of the fork arms (1) facing towards the latter, and the second part of the fork arms (1) further forming an approximately right angle between the legs of the ladder and the second part of the fork arms (1).

4. A rescue apparatus according to claim 1, characterized in that the rescue apparatus may be releasably attached to the general ladder part, the fork arms (1) forming a part of a frame-like structure.

5. A rescue apparatus according to claim 4, characterized in that the frame-like structure comprises a frame (2) having a quadrilateral shape, wherein two edges of the quadrilateral when the frame-like structure is attached to the ladder will be approximately parallel with the rungs of the ladder, whereas the other two edges of the quadrilateral will be approximately parallel with the legs of the ladder when the frame-like structure is attached to the ladder.

6. A rescue apparatus according to claim 5, characterized in that there between the fork arms (1) and the quadrilateral frame (2) is provided a stiffening member in order to prevent deflection of the fork arms (1).

7. A rescue apparatus according to claim 6, characterized in that the stiffening member is a girder, and that the girder forms an edge of a triangle between the quadrilateral frame (2) and one of the fork arms (1).

8. A rescue apparatus according to claim 5, characterized in that the fork arms (1) are attached in, or close to, two of the corners of the quadrilateral frame (2).

9. A rescue apparatus according to claim 4, characterized in that the frame-like structure comprises one or more attachments (3) for being attached to the legs of the ladder and/or the rungs of the ladder.

10. A rescue apparatus according to claim 9, characterized in that the frame-like structure comprises a security attachment for secure attachment against the ladder part, this security attachment preferably being constituted by a spring-loaded locking device.

11. A rescue apparatus according to claim 2, characterized in that the rescue apparatus may be releasably attached to the general ladder part, the fork arms (1) forming a part of a frame-like structure.

12. A rescue apparatus according to claim 3, characterized in that the rescue apparatus may be releasably attached to the general ladder part, the fork arms (1) forming a part of a frame-like structure.

13. A rescue apparatus according to claim 6, characterized in that the fork arms (1) are attached in, or close to, two of the corners of the quadrilateral frame (2).

14. A rescue apparatus according to claim 7, characterized in that the fork arms (1) are attached in, or close to, two of the corners of the quadrilateral frame (2).

15. A rescue apparatus according to claim 5, characterized in that the frame-like structure comprises one or more attachments (3) for being attached to the legs of the ladder and/or the rungs of the ladder.

16. A rescue apparatus according to claim 6, characterized in that the frame-like structure comprises one or more attachments (3) for being attached to the legs of the ladder and/or the rungs of the ladder.

17. A rescue apparatus according to claim 7, characterized in that the frame-like structure comprises one or more attachments (3) for being attached to the legs of the ladder and/or the rungs of the ladder.
